(19) United States
(12) Patent Application Publication
(10) Pub. No.: US 2008/0285293 A1
(43) Pub. Date: Nov. 20, 2008

(54) Outer Mirror

(75) Inventor: Yasuhiro Sato, Shizuoka (JP)

Correspondence Address: KRATZ, QUINTOS & HANSON, LLP, 1420 K Street, N.W., Suite 400, WASHINGTON, DC, 20005, US

(73) Assignee: Murakami Corporation, Shizuoka-shi (JP)

(21) Appl. No.: 11/547,344

(22) PCT Filed: May 12, 2004
(86) PCT No.: PCT/JP2004/006712

§ 371 Date: Oct. 3, 2006

(51) Int. Cl. B60Q 1/00

(52) U.S. Cl. 362/487

(57) ABSTRACT

The purpose of the present invention is to widely illuminate a road surface at a side of a vehicle body along a front-rear direction of the vehicle body before and after housing of the outer mirror. An outer mirror of the present invention is pivotally movable in the front-rear direction of the vehicle body around a base end portion of the outer mirror, and includes a mirror housing which is thrust laterally from a side surface of the vehicle body. In the mirror housing, a light unit and a lens fixed on an optical axis of the light unit are provided. Any one of the light unit and the lens is moved to illuminate identical or substantially identical area on the road surface at the side of the vehicle body before and after pivotal movement of the mirror housing.

### TECHNICAL FIELD

The present invention relates to an outer mirror capable of illuminating a road surface at a side of a vehicle body.

### BACKGROUND ART

There has been an outer mirror capable of illuminating a road surface at a side of a vehicle body for checking his/her own footsteps and for guiding an entrance of a motor vehicle when a vehicle occupant gets on or off the motor vehicle in the night, or for anticrime measures of the motor vehicle. As an outer mirror described above, there has been an outer mirror provided with a light, which is capable of illuminating downward, in a mirror housing attached on a side surface of a vehicle body, the light being configured to turn on the light in conjunction with an opening operation of a door (for example, refer to Japanese Laid-Open Patent Publication No. H11-105621).

Here, in the above-described outer mirror, since it is preferable to widely illuminate the side of the vehicle body along a front-rear direction of the vehicle body, as shown in FIG. 6(a), an anamorphic lens or a cylindrical lens (hereinafter, referred to as “anamorphic lens or the like”), which is capable of changing a horizontal-to-vertical ratio of an illumination area, is fixed on an optical axis of the light, and by changing the ratio of the illumination area G of the light so that the area G becomes an elliptical shape where a major axis is set along the front-rear direction of the vehicle body 1, the road surface at the side of the vehicle body 1 can be widely illuminated along the front-rear direction of the vehicle body 1.

However, if the elliptical illumination area G is set so that the major axis of the elliptical illumination area G is set along the front-rear direction when the outer mirror 50 is thrust laterally as shown in FIG. 6(a), since the anamorphic lens or the like pivotally moves around a base end portion of the outer mirror 50 together with the outer mirror 50 when the outer mirror 50 is housed by pivotally moving laterally around the base end portion of the outer mirror 50 as shown in FIG. 6(b), an orientation of anamorphic lens or the like changes before and after housing of the outer mirror 50. Generally, since the outer mirror 50 is housed by laterally rotating the outer mirror 50 about 90 degrees, the orientation of the anamorphic lens or the like changes 90 degrees. In accordance with this, an illumination area H on a road surface is rendered to be an orientation that is rotated 90 degrees from the illumination area G (refer to FIG. 6(a)). That is, the illumination area H of the road surface becomes an elliptical shape where a minor axis is set along the front-rear direction of the vehicle body 1, thereby causing a problem such that an illumination area along a front-rear direction of a vehicle body becomes narrow.

It is, therefore, an object of the present invention to provide an outer mirror which is capable of illuminating identical or substantially identical area of a road surface at a side of a vehicle body before and after housing of the outer mirror, thus eliminating the aforementioned issues.

### DISCLOSURE OF THE INVENTION

To solve the aforementioned issues, an outer mirror of the present invention is characterized in that the outer mirror includes a mirror housing which is thrust laterally from a side surface of a vehicle body, wherein the mirror housing is capable of pivotal movement in a front-rear direction of the vehicle body about a base end portion of the mirror housing, wherein in the mirror housing, there is provided: a light source unit capable of moving in an up-and-down direction, as well as capable of illuminating a road surface at a side of the vehicle body; and a lens which is fixed on an optical axis of the light source unit, and capable of changing a horizontal-to-vertical ratio of an illumination area of the light source unit based on a distance between the lens and the light source unit, wherein the illumination area of the road surface at the side of the vehicle body becomes identical or substantially identical before and after rotation of the mirror housing by moving the light source unit in the up-and-down direction.

Here, the vehicle body is not limited to that of a motor vehicle, and the outer mirror of the present invention is applicable to various kinds of vehicles.

In addition, the lens which is capable of changing a horizontal-to-vertical ratio of the illumination area of the light source unit based on the distance between the lens and the light source unit is, for example, an existing anamorphic lens, and includes an optical system combining a plurality of lenses.

As described above, in the outer mirror according to the present invention, an illumination area on a road surface can be identical or substantially identical before and after rotation of the mirror housing by moving the light source unit in an up-and-down direction relative to the lens. Through this, for example, when the illumination area is set in advance so that the illumination area becomes an elliptical shape where a major axis is set along a front-rear direction of a vehicle body, a road surface at a side of the vehicle body can be widely illuminated along the front-rear direction of the vehicle body before and after housing of the outer mirror.

Further, the light source unit may be configured to move in the up-and-down direction in conjunction with rotation of the mirror housing.

As described above, the road surface at the side of the vehicle body can be illuminated immediately before and after housing of the outer mirror by moving the light source unit in the up-and-down direction in conjunction with pivotal movement of the mirror housing.

In addition, as another configuration of the outer mirror, the outer mirror may be configured to include a mirror housing which is thrust laterally from a side surface of a vehicle body, wherein the mirror housing is capable of pivotal movement in a front-rear direction of the vehicle body around a base end portion of the mirror housing, wherein in the mirror housing, there is provided: a light source unit capable of illuminating a road surface at a side of the vehicle body; and a lens which is fixed on an optical axis of the light source unit and capable of pivotal movement around the optical axis of the light source unit, and is capable of changing a horizontal-to-vertical ratio of an illumination area by the light source unit based on a quantity of the pivotal movement of the light source unit around the optical axis, wherein the illumination area of the road surface at the side of the vehicle body becomes identical or substantially identical before and after pivotal movement of the mirror housing by pivotally moving the lens around the optical axis of the light source unit.

Here, the lens which is capable of changing a horizontal-to-vertical ratio of the illumination area by the light source unit based on a quantity of the pivotal movement of the light source unit around the optical axis is, for example, an existing anamorphic lens or a cylindrical lens, and further includes an optical system combining a plurality of lenses.

In addition, the light source unit may be rotated around the optical axis in conjunction with pivotal movement of the lens around the optical axis, and a configuration of the outer mirror is not limited.

As described above, in the outer mirror of the present invention, an illumination area of a road surface can be identical or substantially identical before and after pivotal movement of the mirror housing by pivotally moving the lens around the optical axis of the light source unit. Through this, for example, when the illumination area is set in advance so that the illumination area becomes an elliptical shape where a major axis is set along a front-rear direction of a vehicle body, a road surface at a side of the vehicle body can be widely illuminated along the front-rear direction of the vehicle body before and after housing of the outer mirror.

In addition, the light source unit may be configured so that the light source unit pivotally moves around the optical axis of the light source unit in conjunction with pivotal movement of the mirror housing.

As described above, a road surface at a side of a vehicle body can be illuminated immediately before and after housing of the outer mirror by pivotally moving the lens around the optical axis in conjunction with pivotal movement of the mirror housing.

### BRIEF DESCRIPTION OF THE DRAWINGS

FIG. 1 is a rear perspective view showing an outer mirror according to a first embodiment;

FIG. 2 is a perspective view showing a status where a horizontal-to-vertical ratio of an illumination area is changed by an anamorphic lens;

FIG. 3 is an illustration showing an illumination area by an outer mirror according to the first embodiment, (a) is a front perspective view showing the illumination area of the outer mirror being thrust, (b) is a front perspective view showing the illumination area of the outer mirror being housed;

FIG. 4 is a rear perspective view showing an outer mirror according to a second embodiment;

FIG. 5 is a perspective view showing a status where a horizontal-to-vertical ratio of an illumination area is changed by a cylindrical lens;

FIG. 6 is an illustration showing a conventional outer mirror, (a) is a front perspective view showing an illumination area of the outer mirror being thrust, (b) is a front perspective view showing the illumination area of the outer mirror being housed.

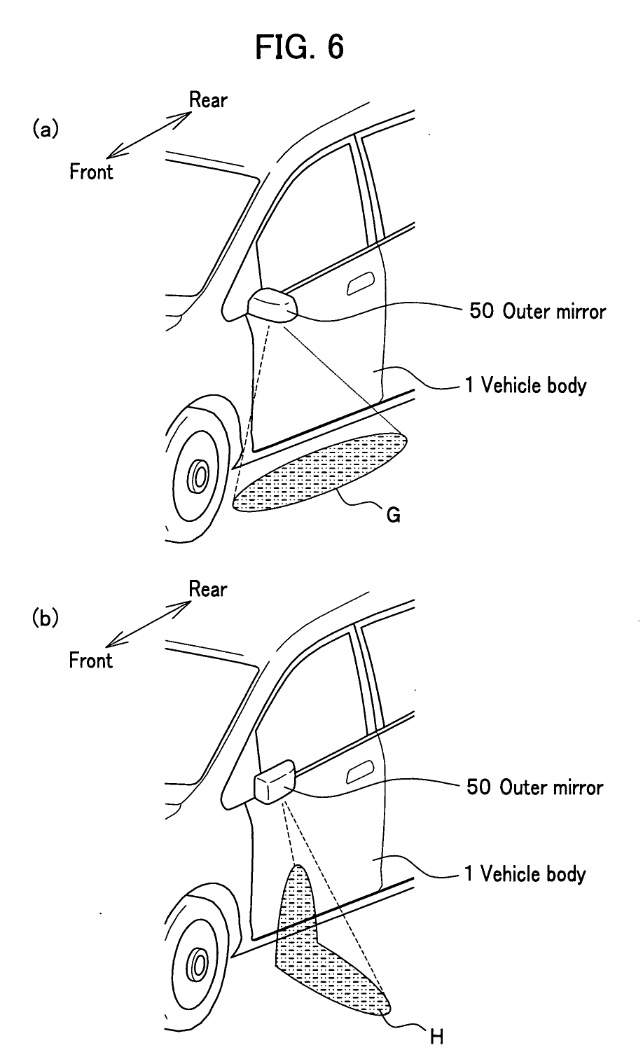

### BEST MODE FOR CARRYING OUT THE INVENTION

Next, embodiments of the present invention will be explained in detail by referring to figures, as needed.

Meanwhile, in an explanation of each embodiment, a duplicated explanation will be omitted.

In the embodiments, an example where an outer mirror of the present invention is applied to a side mirror of a motor vehicle will be explained.

### [First Embodiment]

First, a first embodiment of the present invention will be explained.

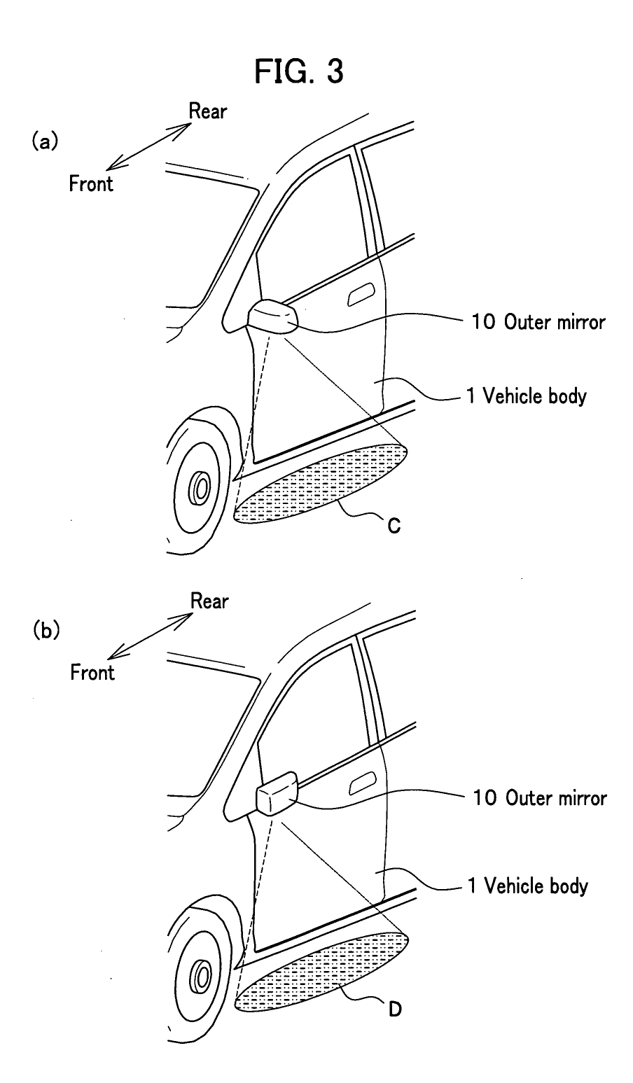

Meanwhile, in the first embodiment, a front-rear direction corresponds to, as shown in FIG. 3, a front-rear direction of a vehicle body 1.

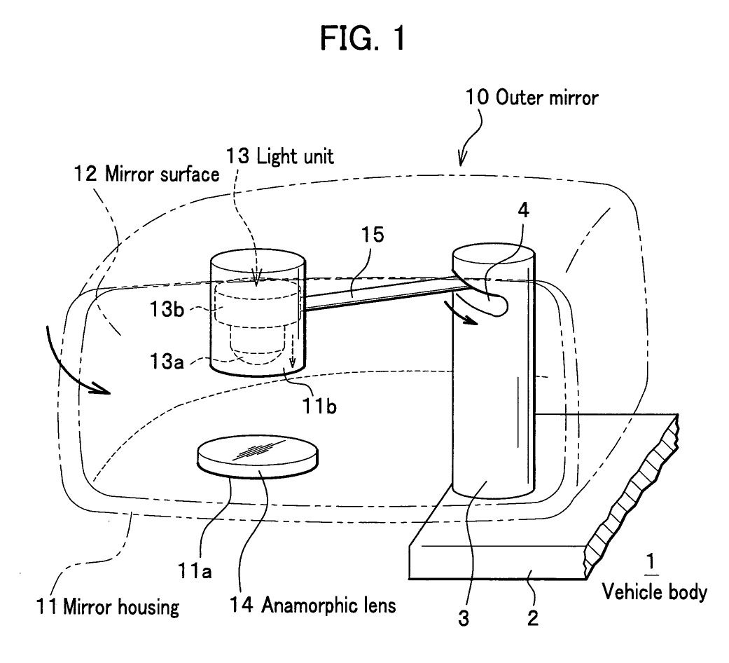

As shown in FIGS. 1 and 3, an outer mirror 10 according to the first embodiment is disposed in a front of a front door of a motor vehicle, and provided with a mirror housing 11 which is thrust laterally from a side surface of the vehicle body 1 and a mirror surface 12 attached to a back surface of the mirror housing 11.

The mirror housing 11 is attached on a mirror base 2 which is thrust laterally from a side of the vehicle body 1, and a fixing shaft 3 which is a columnar member extended upward from the mirror base 2 is inserted in the mirror housing 11. In addition, the mirror housing 11 is configured so that the outer mirror 10 is housed on a side surface of the vehicle body 1, by pivotally moving around the fixing shaft 3 and moving backward (front side in FIG. 1) of the vehicle body 1 by a driving motor (not shown) installed in the mirror housing 11.

In addition, in the mirror housing 11, a light unit 13 (“a light source unit” in the claims) capable of illuminating downward and an anamorphic lens 14, which is on an optical axis of the light unit 13 and fixed on a bottom of the mirror housing 11, are disposed.

Further, on the bottom of the mirror housing 11, a through hole 11a is formed at a location corresponding to the anamorphic lens 14 so that a light beam radiated from the light unit 13 illuminates a road surface at a side of the vehicle body 1 through the anamorphic lens 14 and the through hole 11a.

The light unit 13 includes a light emitting element 13a for illuminating downward and a body 13b having a control unit for controlling a power supply to the light emitting element 13a, and on a side surface of the body 13b, one end of a rod 15 extending horizontally to the fixed shaft 3 of the vehicle body 1 is attached, then, the light unit 13 is supported by the rod 15. In addition, the light unit 13 is housed in a cover member 11b which has a cylindrical shape and is disposed in the mirror housing 11 by drooping down from a top surface of the mirror housing 11, and the rod 15 is attached to the light unit 13 through a long hole (not shown), which is long in an up-and-down direction, disposed on a side surface of the cover member 11b. Through this, the light unit 13 and the rod 15 pivotally move in conjunction with the mirror housing 11 because they are pushed by the cover member 11b when the mirror housing 11 pivotally moves.

Meanwhile, in the fixing shaft 3 of the vehicle body 1, a guiding groove 4 which has a U-shape and is helically formed toward obliquely downward is formed, and the other end of the rod 15 is inserted in the guiding groove 4. Through this, the rod 15 moves along the guiding groove 4 when the rod 15 is pivotally moved horizontally in conjunction with the mirror housing 11.

That is, when the outer mirror 10 is housed, the rod 15 moves obliquely downward along the guiding groove 4, and when the outer mirror is returned from a housed status, the rod 15 moves obliquely upward along the guiding groove 4.

Through this, the light unit 13 supported by the rod 15 moves downward within the cover member 11b of the mirror housing 11 when the outer mirror 10 is housed, and when the outer mirror is returned from the housed state, the light unit 13 moves upward within the cover member 11b of the mirror housing 11. Thus, the light unit 13 moves an up-and-down direction against the anamorphic lens 14 within the mirror housing 11 in conjunction with pivotal movement of the mirror housing 11.

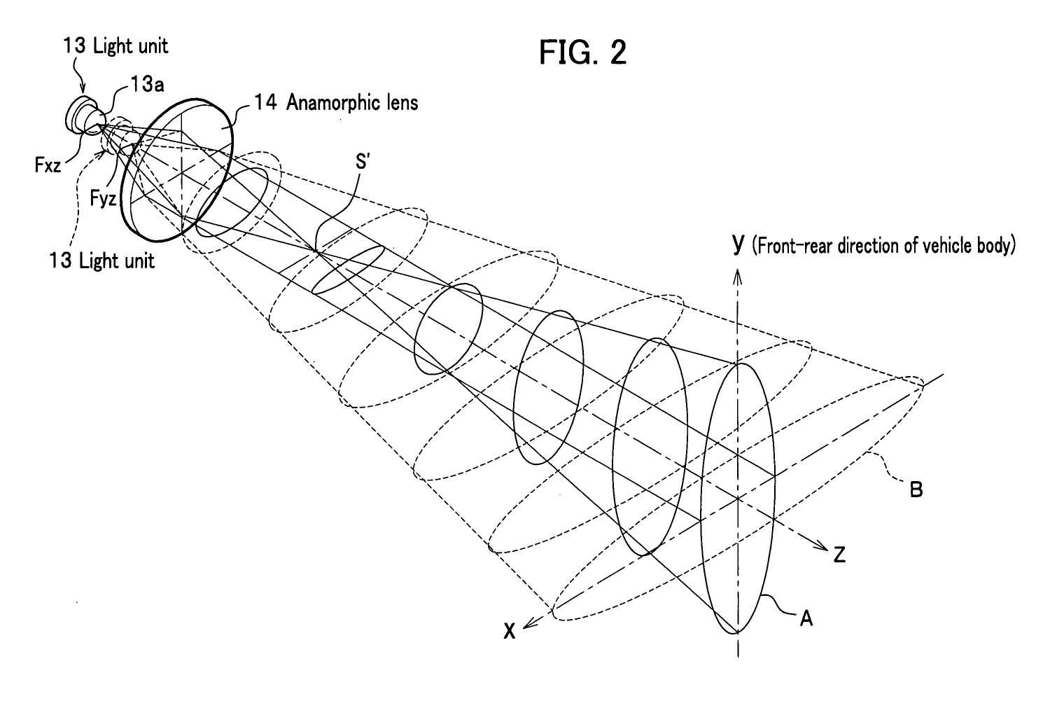

The anamorphic lens 14 is, as shown in FIG. 2, a lens having different focal distances on an X-Z plane which includes an optical axis of a Z-axis and an X-axis and on a Y-Z plane which includes the Z-axis and a Y-axis, and by using these lenses, in the embodiment, a horizontal-to-vertical ratio of an illumination area of the light unit 13 can be changed based on a distance to the light unit 13 as a light source. Meanwhile, in the embodiment, the X-axis and the Y-axis intersect at right angles with the Z-axis of the optical axis. However, since the anamorphic lens 14 is a lens having different focal distances on two planes formed by the Z-axis and one of two lines intersecting with the Z-axis, intersection angles of the two lines with the Z-axis are not limited.

In the anamorphic lens 14 shown in FIG. 2, a light source is arranged at a focus F_{XZ} of the anamorphic lens 14 on the X-Z plane when the light unit 13 is arranged at a location shown with a solid line; as a result, a light beam passing through the anamorphic lens 14 becomes in parallel with the Z-axis on the X-Z plane. In addition, on the Y-Z plane, a light beam passing through the anamorphic lens 14 is diffused after being focused once at an imaging point S′ because a location of the light unit 13 is more distant than a focus F_{YZ} of the Y-Z plane, thereby resulting in an elliptical illumination area A where a major axis is set in the Y-axis direction (a front-rear direction of a vehicle body).

Further, as shown with a dotted line, when the light unit 13 is moved to an anamorphic lens 14 side from a location of the solid line to shorten a distance to the anamorphic lens 14, and arranged at the focus F_{YZ} of the anamorphic lens 14 on the Y-Z plane, since the light unit 13 approaches closer to the anamorphic lens 14 than the focus F_{XZ} on the X-Z plane, a light beam passing through the anamorphic lens 14 diffuses, and as a result, the light beam becomes parallel to the Z-axis. Through this, the light beam illuminates an elliptical illumination area B where a major axis is set in the X-axis direction, that is, a direction perpendicular to the front-rear direction of the vehicle body 1 (refer to FIG. 3).

Meanwhile, the light unit 13 may be moved on the Z-axis for arranging the light unit 13 at an arbitrary location so that the light beam illuminates the illumination areas A, B, without matching the light unit 13 as a light source with the focus F_{XZ} on the X-Z plane or the focus F_{YZ} on the Y-Z plane as the embodiment.

Therefore, in the outer mirror 10 according to the first embodiment, since the light unit 13 moves, as shown in FIG. 1, in an up-and-down direction against the anamorphic lens 14 in conjunction with pivotal movement of the mirror housing 11, a horizontal-to-vertical ratio of an illumination area of a road surface is changed.

In addition, as shown in FIG. 3(a), when the outer mirror 10 is being thrust laterally, a distance between the light unit 13 and the anamorphic lens 14 (refer to FIG. 1) is set so that the light beam illuminates an elliptical illumination area C where a major axis is set along the front-rear direction of the vehicle body 1; further, as shown in FIG. 3(b), when the outer mirror 10 is being housed, the distance is set so that the light beam illuminates an elliptical illumination area D where a major axis is set along the front-rear direction of the vehicle body 1. Like the above, a moving distance of the light unit 13 (refer to FIG. 1) in an up-and-down direction, or a focal distance of the anamorphic lens 14, and a distance between the anamorphic lens 14 and the light unit 13 are set so that each of the illumination areas C, D becomes substantially identical before and after housing of the outer mirror 10. Specifically, the light beam illuminates the illumination areas C, D by moving the light unit 13 as a light source to arbitrary two points which are in the vicinity of the focus F_{XZ} or focus F_{YZ} in FIG. 2.

Through the above, in the outer mirror 10 according to the first embodiment, since an illumination area on a road surface at a side of the vehicle body 1 becomes substantially identical before and after pivotal movement of the mirror housing 11, the road surface at the side of the vehicle body 1 can be widely illuminated along the front-rear direction of the vehicle body 1 before and after housing of the outer mirror 10. Through this, a safety of a vehicle occupant at getting on and off a vehicle in the night, and a visual perceptibility of an entrance and anticrime effect of the vehicle can be improved.

Meanwhile, in the first embodiment, as shown in FIG. 2, the outer mirror 10 is configured so that the light beam illuminates the elliptical illumination area B where a major axis is the X-axis, by approaching the light unit 13 of which location is set so that the light beam illuminates the elliptical illumination area A where a major axis is set in the Y-axis direction (a front-rear direction of a vehicle body) to the anamorphic lens 14. However, when the outer mirror is configured so that the illumination area B becomes an elliptical shape where a major axis is in a front-rear direction of a vehicle body by setting the X-axis in the front-rear direction of the vehicle body, a road surface at a side of the vehicle body 1 can be widely illuminated along a front-rear direction of the vehicle body 1, by distancing the light unit 13 from the anamorphic lens 14 in conjunction with pivotal movement of the mirror housing 11 (refer to FIG. 11), thereby illuminating the elliptical illumination area A where a major axis is the Y-axis direction.

### [Second Embodiment]

Next, a second embodiment of the present invention will be explained.

An outer mirror according to the second embodiment is configured to be almost identical to the outer mirror according to the first embodiment, but a configuration for changing a horizontal-to-vertical ratio of an illumination area is different from that of the first embodiment.

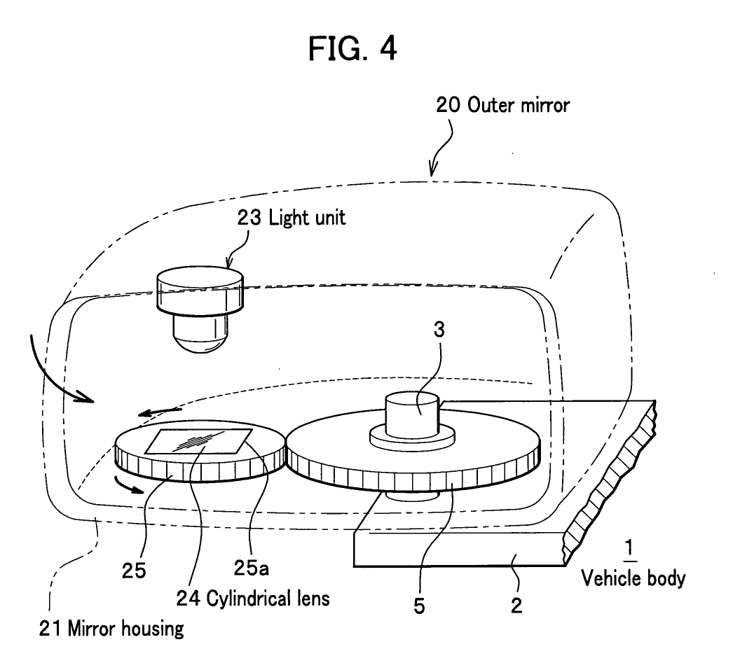

As shown in FIG. 4, in a mirror housing 21 according to the second embodiment, a light unit 23 fixed on the mirror housing 21 and a cylindrical lens 24 capable of pivotal movement around an optical axis of the light unit 23 on the optical axis of the light unit 23 are provided. In addition, on a bottom of the mirror housing 21, a through hole (not shown) is formed at a location corresponding to the cylindrical lens 24, and a light beam radiated from the light unit 23 passes through the cylindrical lens 24 and the through hole, and illuminates a road surface at a side of the vehicle body 1.

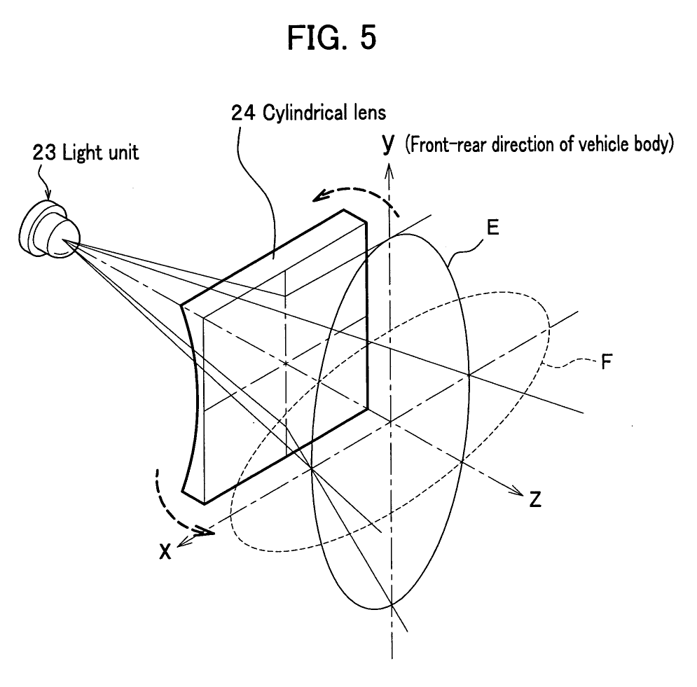

The cylindrical lens 24 is, as shown in FIG. 5, an existing lens where an incident surface is formed in a circular concave, and a horizontal-to-vertical ratio of an illumination area can be changed based on a quantity of pivotal movement around an optical axis. Specifically, when the cylindrical lens 24 is arranged in an orientation as shown in FIG. 5, the light beam illuminates an elliptical illumination area E where a major axis is oriented in a Y-axis direction (a front-rear direction of a vehicle body), in addition, when the cylindrical lens 24 is rotated 90 degrees around the optical axis, the light beam illustrates an elliptical illumination area F where a major axis is an X-axis. Meanwhile, the cylindrical lens 24 has various shapes other than the shape according to the embodiment where the incident surface is formed in the circular concave, such as a shape where an outgoing surface is formed in a circular concave, a shape where an incident or outgoing surface is formed in a circular convex, in addition, a shape where the incident and outgoing surfaces are formed in a circular concave or a circular convex, and a shape where one of the incident and outgoing surfaces is a circular concave and the other is a circular convex.

The cylindrical lens 24 is fitted, as shown in FIG. 4, into a through hole 25a of a rotating and moving gear 25 which is attached on a bottom of the mirror housing 21 in a manner that permits the cylindrical lens 24 to rotate around an optical axis of the light unit 23, and configured so as to rotate around the optical axis together with the rotating and moving gear 25.

In addition, the rotating and moving gear 25 is engaged with a fixed gear 5 which is disposed at a perimeter surface of a fixed shaft 3 of the vehicle body 1, and when the mirror housing 21 is pivotally moved laterally, the rotating and moving gear 25 pivotally moves (revolution) around the fixed shaft 3 along the perimeter of the fixed gear 5, while pivotally moving around the optical axis (rotation). As described above, the horizontal-to-vertical ratio of an illumination area of a road surface is changed by pivotally moving the cylindrical lens 24 around the optical axis of the light unit 23 in conjunction with pivotal movement of the mirror housing 21.

Then, as FIG. 3 of the first embodiment, when the outer mirror 20 is being thrust laterally, an orientation of the cylindrical lens 24 (refer to FIG. 4) is set so that the light beam illuminates an elliptical illumination area where a major axis is set along a front-rear direction of the vehicle body 1; further, when the outer mirror is being housed, the orientation of the cylindrical lens 24 is set so that the light beam illuminates an elliptical illumination area where a major axis is set along the front-rear direction of the vehicle body 1. As described above, a quantity of pivotal movement of the cylindrical lens 24 is set so that each illumination area before and after housing of the outer mirror becomes substantially identical.

Therefore, in the outer mirror 20 according to the second embodiment, as the first embodiment, since the illumination area on a road surface at a side of the vehicle body 1 becomes substantially identical before and after pivotal movement of the mirror housing 21, the road surface of the side of the vehicle body 1 can be widely illuminated along the front-rear direction of the vehicle body 1 before and after housing of the outer mirror 20. Through this, a safety of a vehicle occupant at getting on and off a vehicle in the night, and a visual perceptibility of an entrance and anticrime effect of the vehicle can be improved.

Meanwhile, in the second embodiment, as shown in FIG. 5, the cylindrical lens 24, of which position is set so that the light beam illuminates an elliptical illumination area E where a major axis is the Y-axis direction (a front-rear direction of a vehicle body), is rotated 90 degrees in a direction shown with an arrow in FIG. 5, thereby to illuminate an elliptical illumination area F where a major axis is the X-axis, but the cylindrical lens 24 may be set so that the illumination area F becomes an elliptical shape where a major axis is in a front-rear direction of a vehicle body by setting the X-axis in the front-rear direction of the vehicle body, and may be rotated 90 degrees in an opposite direction of the arrow shown in FIG. 5, thereby making the light beam illuminates the elliptical illumination area E where a major axis is the Y-axis direction, so as to widely illuminate a road surface at a side of the vehicle body 1 along a front-rear direction of the vehicle body 1 before and after housing of the outer mirror 20.

With the above, the embodiments of the present invention have been explained. However, the present invention is not limited to the above-described embodiments. For example, in each embodiment, each illumination area is set to become substantially identical before and after housing of the outer mirrors 10, 20 (refer to FIG. 3). However, it is needless to say that the each illumination area may be set to become identical.

In addition, the displacement of the light unit in the first embodiment and rotation of the cylindrical lens in the second embodiment may be driven by an actuator using a driving source such as an electric motor, and its mechanism is not limited thereto.

In addition, in the second embodiment shown in FIG. 4, the light unit 23 may be configured so that the light unit 23 pivotally moves around an optical axis together with the cylindrical lens 24. Further, an anamorphic lens may be used instead of the cylindrical lens 24, and if each illumination area becomes identical or substantially identical before and after housing of the outer mirror 20, a configuration of a lens is not limited and various kinds of lenses can be used.

Furthermore, various kinds of lenses also can be used in the first embodiment, and in addition, in the first and second embodiments, a horizontal-to-vertical ratio of an illumination area may be changed by using an optical system combining a plurality of lenses.

### INDUSTRIAL APPLICABILITY

According to an outer mirror of the present invention, since an illumination area becomes identical or substantially identical before and after pivotal movement of a mirror housing, an identical or substantially identical road surface at a side of a vehicle body can be illuminated before and after housing the outer mirror. Through this, an intended area can be illuminated certainly without being effected by a housing state of the outer mirror.

1. An outer mirror, comprising a mirror housing which is thrust laterally from a side surface of a vehicle body,
wherein the mirror housing is pivotally movable in a front-rear direction of the vehicle body about a base end portion of the mirror housing,
wherein in the mirror housing, there is provided:
a light source unit capable of moving in an up-and-down direction, as well as capable of illuminating a road surface at a side of the vehicle body; and
a lens which is fixed on an optical axis of the light source unit and capable of changing a horizontal-to-vertical ratio of an illumination area illuminated with the light source unit based on a distance to the light source unit, wherein the light source unit is moved in the up-and-down direction so that the illumination area of the road surface at the side of the vehicle body becomes identical or substantially identical before and after pivotal movement of the mirror housing.

2. The outer mirror according to claim 1,
wherein the light source unit is configured to move in the up-and-down direction in conjunction with pivotal movement of the mirror housing.

3. An outer mirror comprising a mirror housing which is thrust laterally from a side surface of a vehicle body,
wherein the mirror housing is pivotally movable in a front-rear direction of the vehicle body around a base end portion of the mirror housing,
wherein in the mirror housing, there is provided:
a light source unit capable of illuminating a road surface at a side of the vehicle body; and
a lens which is fixed on an optical axis of the light source unit, capable of pivotal movement around the optical axis of the light source unit, and capable of changing a horizontal-to-vertical ratio of an illumination area with the light source unit based on a quantity of the pivotal movement of the light source unit around the optical axis of the light source unit,
wherein the illumination area of the road surface at the side of the vehicle body becomes identical or substantially identical before and after pivotal movement of the mirror housing by pivotally moving the lens around the optical axis of the light source unit.

4. The outer mirror according to claim 3,
wherein the lens is configured to pivotally move around the optical axis of the light source unit in conjunction with pivotal movement of the mirror housing.
